(19) United States
(12) Patent Application Publication
(10) Pub. No.: US 2025/0133428 A1
(43) Pub. Date: Apr. 24, 2025

(54) NETWORK ENTITY ENERGY USAGE REPORTING

(71) Applicant: Qualcomm Incorporated, San Diego, CA (US)

(72) Inventors: Naeem AKL, Bridgewater, NJ (US); Navid ABEDINI, Basking Ridge, NJ (US)

(21) Appl. No.: 18/493,161

(22) Filed: Oct. 24, 2023

(51) Int. Cl. H04W 24/08; H04W 76/12

(52) U.S. Cl. CPC H04W 24/08; H04W 76/12

(57) ABSTRACT

Various aspects of the present disclosure generally relate to wireless communication. In some aspects, a network node and a network entity may receive a request associated with a protocol data unit (PDU) session. The network node and the network entity may establish, based at least in part on the request, a tunnel associated with the PDU session. The network node may transmit, and the network entity may receive, via the tunnel, energy usage information. The network entity may transmit, based at least in part on the energy usage information, an energy usage report. Numerous other aspects are described.

### FIELD OF THE DISCLOSURE

Aspects of the present disclosure generally relate to wireless communication and to techniques and apparatuses for energy usage reporting by a network entity.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a network node for wireless communication. The network node may include one or more memories and one or more processors coupled to the one or more memories. The one or more processors may be configured, individually or in any combination, to receive a request associated with a protocol data unit (PDU) session. The one or more processors may be configured, individually or in any combination, to establish, based at least in part on the request, a tunnel associated with the PDU session. The one or more processors may be configured, individually or in any combination, to transmit, via the tunnel, energy usage information.

Some aspects described herein relate to a network entity for wireless communication. The network entity may include one or more memories and one or more processors coupled to the one or more memories. The one or more processors may be configured, individually or in any combination, to receive a request associated with a PDU session. The one or more processors may be configured, individually or in any combination, to establish, based at least in part on the request, a tunnel associated with the PDU session. The one or more processors may be configured, individually or in any combination, to receive, via the tunnel, energy usage information. The one or more processors may be configured, individually or in any combination, to transmit, based at least in part on the energy usage information, an energy usage report.

Some aspects described herein relate to a method of wireless communication performed by a network node. The method may include receiving a request associated with a PDU session. The method may include establishing, based at least in part on the request, a tunnel associated with the PDU session. The method may include transmitting, via the tunnel, energy usage information.

Some aspects described herein relate to a method of wireless communication performed by a network entity. The method may include receiving a request associated with a PDU session. The method may include establishing, based at least in part on the request, a tunnel associated with the PDU session. The method may include receiving, via the tunnel, energy usage information. The method may include transmitting, based at least in part on the energy usage information, an energy usage report.

Some aspects described herein relate to a non-transitory computer-readable medium that stores a set of instructions for wireless communication by a network node. The set of instructions, when executed by one or more processors of the network node, may cause the network node to receive a request associated with a PDU session. The set of instructions, when executed by one or more processors of the network node, may cause the network node to establish, based at least in part on the request, a tunnel associated with the PDU session. The set of instructions, when executed by one or more processors of the network node, may cause the network node to transmit, via the tunnel, energy usage information.

Some aspects described herein relate to a non-transitory computer-readable medium that stores a set of instructions for wireless communication by a network entity. The set of instructions, when executed by one or more processors of the network entity, may cause the network entity to receive a request associated with a PDU session. The set of instructions, when executed by one or more processors of the network entity, may cause the network entity to establish, based at least in part on the request, a tunnel associated with the PDU session. The set of instructions, when executed by one or more processors of the network entity, may cause the network entity to receive, via the tunnel, energy usage information. The set of instructions, when executed by one or more processors of the network entity, may cause the network entity to transmit, based at least in part on the energy usage information, an energy usage report.

Some aspects described herein relate to an apparatus for wireless communication. The apparatus may include means for receiving a request associated with a PDU session. The apparatus may include means for establishing, based at least in part on the request, a tunnel associated with the PDU session. The apparatus may include means for transmitting, via the tunnel, energy usage information.

Some aspects described herein relate to an apparatus for wireless communication. The apparatus may include means for receiving a request associated with a PDU session. The apparatus may include means for establishing, based at least in part on the request, a tunnel associated with the PDU session. The apparatus may include means for receiving, via the tunnel, energy usage information. The apparatus may include means for transmitting, based at least in part on the energy usage information, an energy usage report.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a 5G network architecture that supports a wireless telecommunications system for data services, in accordance with the present disclosure.

FIG. 5 is a diagram illustrating an example of network entity energy usage reporting, in accordance with the present disclosure.

FIG. 6 is a diagram illustrating an example of an energy usage reporting process, in accordance with the present disclosure.

FIG. 7 is a diagram illustrating an example of a 5G network architecture that supports network entity energy usage reporting, in accordance with the present disclosure.

FIG. 8 is a diagram illustrating an example of an energy usage reporting process involving a decomposed radio access network (RAN), in accordance with the present disclosure.

FIG. 9 is a diagram illustrating an example process performed, for example, at a network node or an apparatus of a network node, in accordance with the present disclosure.

FIG. 10 is a diagram illustrating an example process performed, for example, at a network entity or an apparatus of a network entity, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

The topic of energy efficiency in communication networks is garnering increasing interest from network operators, standards organizations, the networking industry at large, and governmental bodies, particularly in the 6G context, and efforts are underway to offer energy efficiency as a service. Energy efficiency as a service allows a user equipment (UE) to receive a network service in an energy-efficient manner, thereby offering improvements in the sustainability and green networks spaces. For example, the UE may be authorized to consume a given amount of energy while using the network service for a given period of time. However, different network nodes may obtain respective pieces of information that the energy efficiency as a service can use to perform monitoring or charging based on energy consumed by the UE. For example, the UE can access a radio access network (RAN) via multiple network nodes and/or via multiple radio access technologies (RATs) (e.g., 4G, 5G, 6G, Wi-Fi, or the like). As a result, a single network node may not have sufficient information for a core network to provide the energy efficiency as a service.

Various aspects relate generally to energy usage reporting by a network entity. Some aspects more specifically relate to user-plane-based solutions for energy usage (e.g., efficiency) reporting. In some examples, a session management function (SMF) may transmit a request associated with a protocol data unit (PDU) session to a network node and/or to a network entity. The RAN and the network entity may establish a tunnel associated with the PDU session based at least in part on the request(s) associated with the PDU session. The network node may transmit, and the network entity may receive, energy usage information via the tunnel. The network entity may transmit an energy usage report based at least in part on the energy usage information.

The network node may transmit the energy usage information, the network entity may receive the energy usage information, and/or the network entity may transmit the energy usage report based at least in part on an energy usage monitoring configuration. In some aspects, the network node may receive an energy usage monitoring configuration from the SMF (e.g., any suitable time before the network node transmits energy usage information). In some aspects, the network entity may transmit, and the network node may receive, the energy usage monitoring configuration via the tunnel.

Particular aspects of the subject matter described in this disclosure can be implemented to realize one or more of the following potential advantages. In some examples, by transmitting the energy usage information via the tunnel, receiving the energy usage information via the tunnel, and/or transmitting the energy usage report, the described techniques can be used to provide a user-plane-based solution for energy usage (e.g., efficiency) reporting, thereby enabling robust energy usage reporting and, ultimately, conserving energy consumed by a UE. For example, the network entity (e.g., a user plane function (UPF)) may obtain a significant portion of (e.g., all) user plane network traffic data flowing to or from the UE. As a result, the network entity may report energy usage based on energy usage information obtained, via the user plane, from the RAN (e.g., one or more network nodes).

The network node receiving the energy usage monitoring configuration from the SMF may enable the network node to receive the energy usage monitoring configuration via the control plane, which may reduce impact on user plane traffic. The control plane may carry detailed energy usage monitoring configuration information and/or piggyback the energy usage monitoring configuration on other configurations that are carried in the control plane. The network entity transmitting, and the network node receiving, the energy usage monitoring configuration via the tunnel may enable the energy usage monitoring configuration to be transmitted via a similar mechanism as the energy usage information (e.g., via the user plane). The user plane may enable dynamic monitoring activation or deactivation and/or fine-granularity reporting (e.g., reporting of energy consumed to communicate one specific PDU).

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

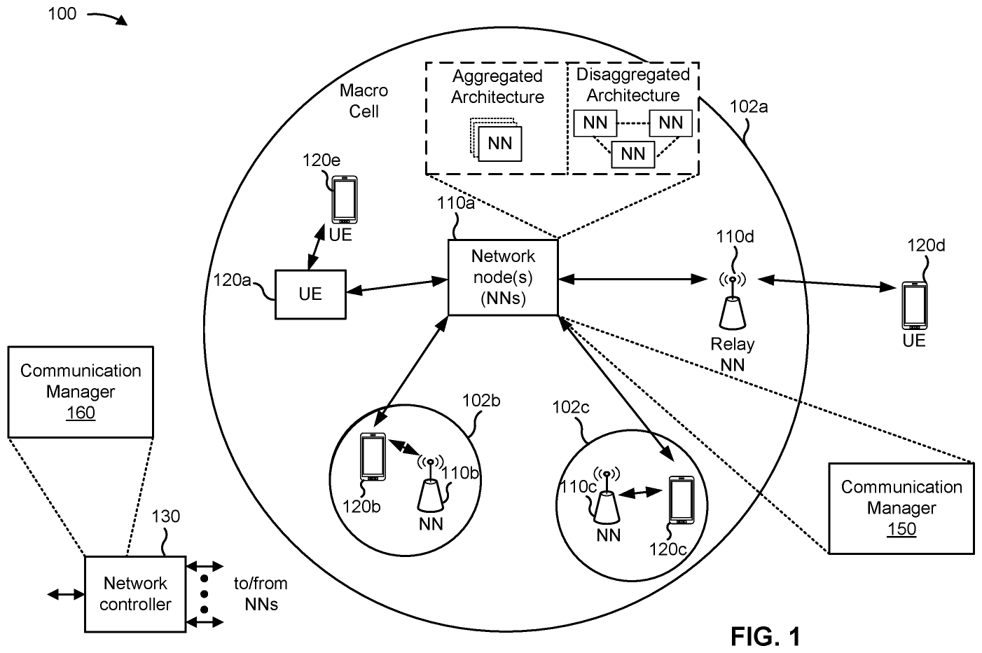

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device. In some examples, the network controller 130 may be, or include, a network entity (e.g., a core network device).

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the network node 110 may include a communication manager 150. As described in more detail elsewhere herein, the communication manager 150 may receive a request associated with a PDU session; establish, based at least in part on the request, a tunnel associated with the PDU session; and transmit, via the tunnel, energy usage information. Additionally, or alternatively, the communication manager 150 may perform one or more other operations described herein.

In some aspects, the network entity may include a communication manager 160. As described in more detail elsewhere herein, the communication manager 160 may receive a request associated with a PDU session; establish, based at least in part on the request, a tunnel associated with the PDU session; receive, via the tunnel, energy usage information; and transmit, based at least in part on the energy usage information, an energy usage report. Additionally, or alternatively, the communication manager 160 may perform one or more other operations described herein.

As indicated above, FIG. 1 is provided as an example. Other examples may differ from what is described with regard to FIG. 1.

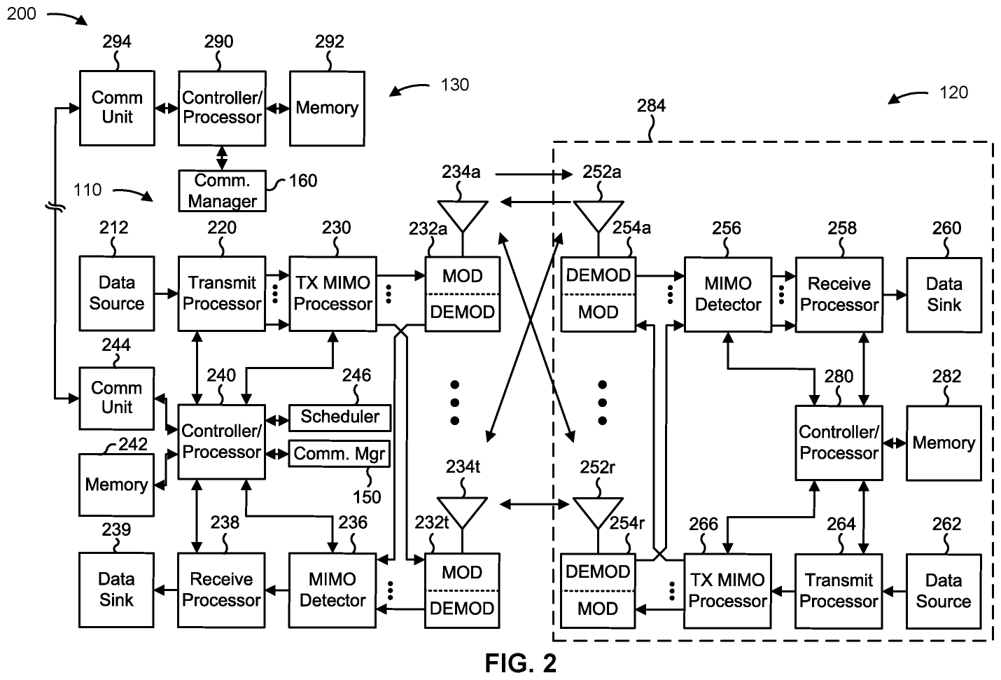

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network, such as a network entity. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

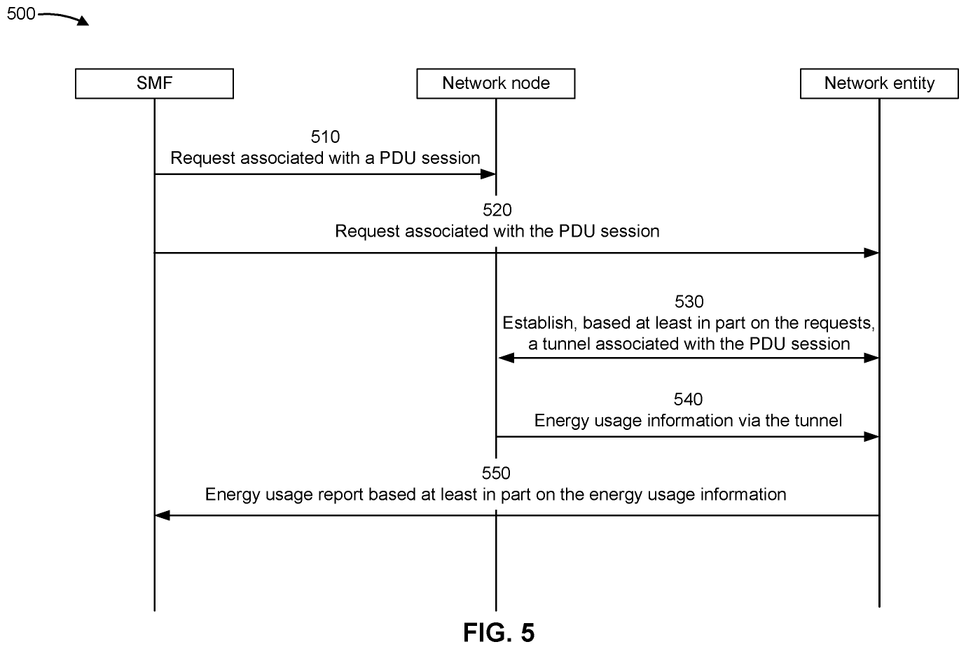

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-12).

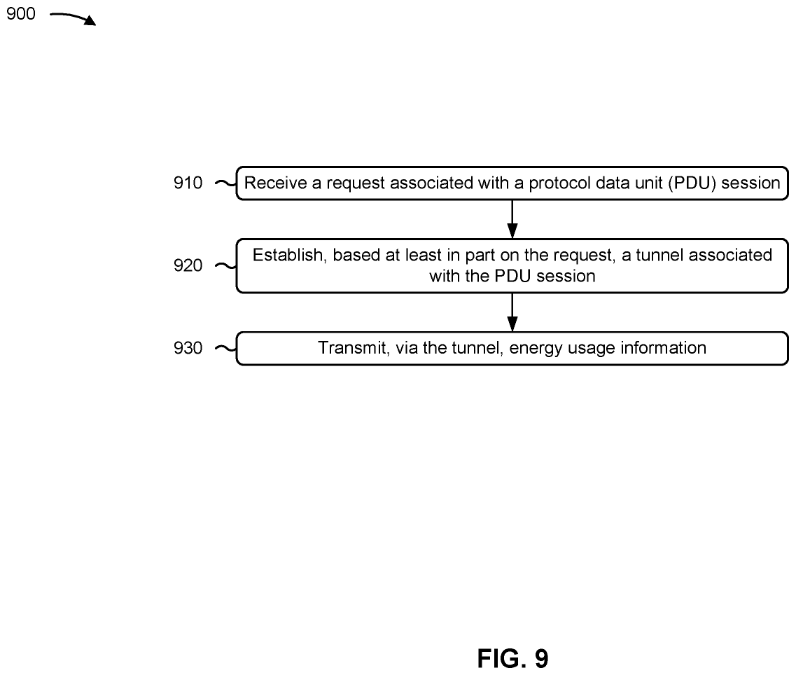

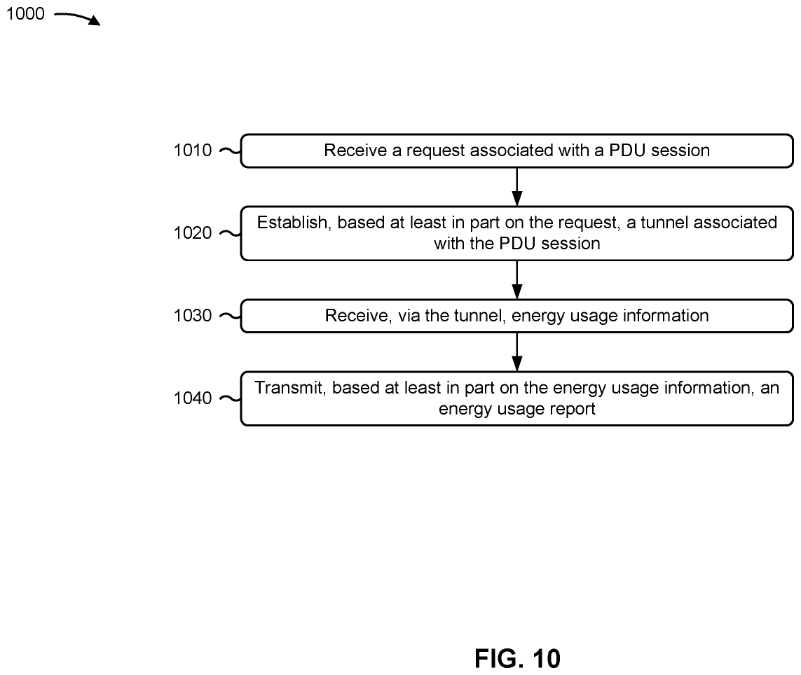

The controller/processor 240 of the network node 110, the controller/processor 280 of the UE 120, and/or any other component(s) of FIG. 2 may perform one or more techniques associated with energy usage reporting by a network entity, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the network node 110 includes means for receiving a request associated with a PDU session; means for establishing, based at least in part on the request, a tunnel associated with the PDU session; and/or means for transmitting, via the tunnel, energy usage information. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a network entity includes means for receiving a request associated with a PDU session; means for establishing, based at least in part on the request, a tunnel associated with the PDU session; means for receiving, via the tunnel, energy usage information; and/or means for transmitting, based at least in part on the energy usage information, an energy usage report. In some aspects, the means for the network entity to perform operations described herein may include, for example, one or more of communication unit 294, controller/processor 290, and memory 292.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

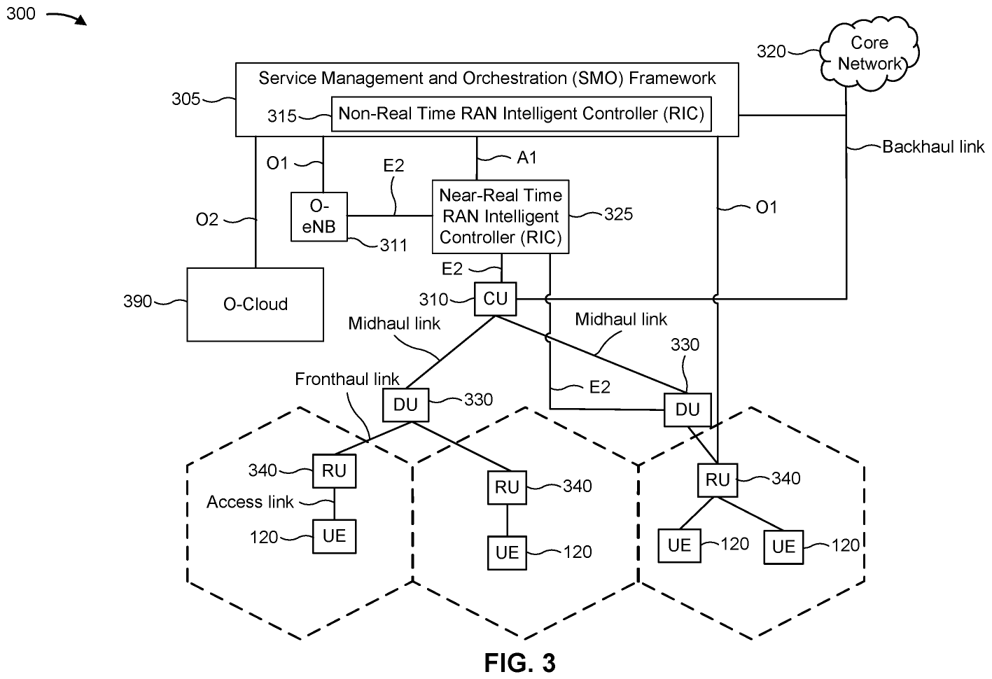

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

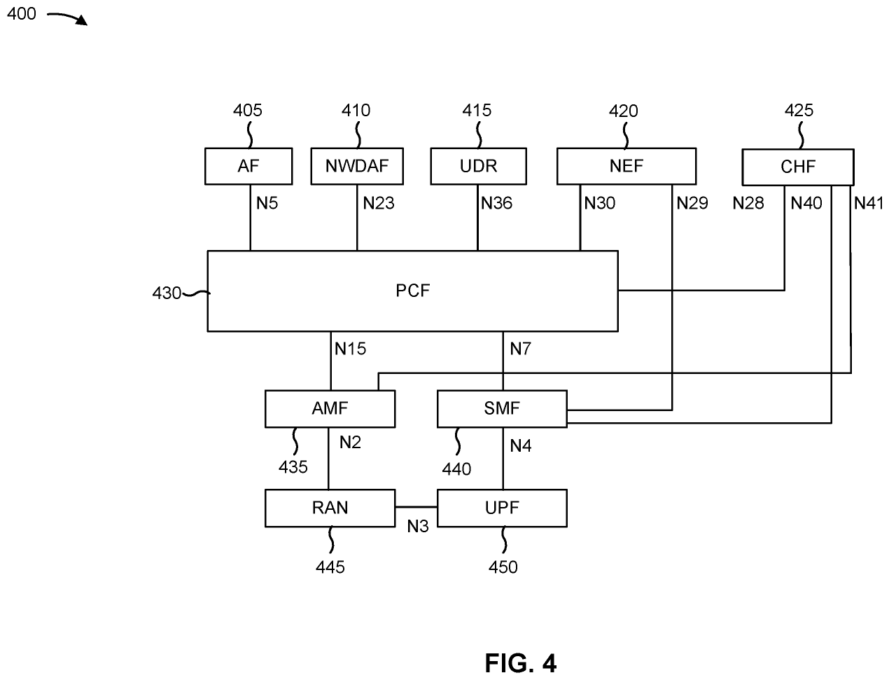

FIG. 4 is a diagram illustrating an example 400 of a 5G network architecture that supports a wireless telecommunications system for data services, in accordance with the present disclosure.

The 5G network architecture includes an application function (AF) 405, a network data analytics function (NWDAF) 410, a unified data repository (UDR) 415, a network exposure function (NEF) 420, a charging function (CHF) 425, a policy control function (PCF) 430, an access and mobility management function (AMF) 435, an SMF 440, a RAN 445, and a UPF 450.

The AF 405 includes one or more devices that support application influence on traffic routing, access to the NEF 420, and/or policy control, among other examples.

The NWDAF 410 includes one or more devices that support data collection and analysis associated with the wireless telecommunications system.

The UDR 415 includes one or more devices that support storage of subscription information (e.g., in a centralized database).

The NEF 420 includes one or more devices that support exposure of capabilities and/or events in the wireless telecommunications system to help other entities in the wireless telecommunications system discover network services.

The CHF 425 includes one or more devices that support usage data collection and billing. The CHF 425 may grant credit to the SMF 440. For example, interactions between the SMF 440 and the CHF 425 may be based on credits. For example, the CHF 425 may credit, to the SMF 440, a given quantity of bits that a UE may consume on a particular PDU session. The SMF 440 may be triggered, at the expiry of the credit, to report to the CHF 425 that the given quantity of bits has been consumed by the UE. The CHF may then determine whether to report (e.g., provide) additional credit to the SMF 440 or terminate service for the UE.

The PCF 430 includes one or more devices that provide a policy framework that incorporates network slicing, roaming, packet processing, and/or mobility management, among other examples. For example, the PCF 430 may configure one or more policies on the AMF 435 and/or the SMF 440. For example, interactions between the SMF 440 and the CHF 425 may be based on policy.

The AMF 435 includes one or more devices that act as a termination point for non-access stratum (NAS) signaling and/or mobility management, among other examples. The AMF 435 may provide, to the RAN 445, indications of UE and/or slice caps (e.g., per-UE or per-network-slice maximum usage thresholds).

The SMF 440 includes one or more devices that support the establishment, modification, and release of communication sessions in the wireless telecommunications system. For example, the SMF 440 may configure traffic steering policies at the UPF 450 and/or may enforce UE internet protocol (IP) address allocation and policies, among other examples. The SMF 440 may provide PDU session and/or QoS flow configurations to the RAN 445 and/or the UPF 450. The SMF 440 may report data usage to the PCF 430 for usage monitoring and/or to the CHF 425 for charging.

The RAN 445 may include one or more network nodes (e.g., network node 110).

The UPF 450 includes one or more devices that serve as an anchor point for intra-RAT and/or inter-RAT mobility. The UPF 450 may apply rules to packets, such as rules pertaining to packet routing, traffic reporting, and/or handling user plane QoS, among other examples. The UPF 450 may report served data to the SMF 440 on a per-PDU-session, per-service-data-flow, and/or per-QoS-flow basis.

A UE may access a data network via the RAN 445 and the UPF 450. For example, the UE may establish a PDU session with the data network via the RAN 445 and the UPF 450. The UPF 450 and the data network may transport data within the PDU session via one or more service data flows (SDFs). For example, in a streaming use case, the PDU session may be associated with one data SDF and one voice SDF. The RAN 445 and the UPF 450 may transport data within the PDU session via one or more QoS flows associated with one or more of the SDFs. The UE may support up to 256 PDU sessions.

As indicated above, FIG. 4 is provided as an example. Other examples may differ from what is described with respect to FIG. 4.

The topic of energy efficiency in communication networks is garnering increasing interest from network operators, standards organizations, the networking industry at large, and governmental bodies, particularly in the 6G context, and efforts are underway to offer energy efficiency as a service. Energy efficiency as a service allows a UE to receive a network service in an energy-efficient manner, thereby offering improvements in the sustainability and green networks spaces. For example, the UE may be authorized to consume a given amount of energy while using the network service for a given period of time. However, different network nodes may obtain respective pieces of information that the energy efficiency as a service can use to perform monitoring or charging based on energy consumed by the UE. For example, the UE can access a RAN via multiple network nodes and/or via multiple RATs (e.g., 4G, 5G, 6G, Wi-Fi, or the like). As a result, a single network node may not have sufficient information for a core network to provide the energy efficiency as a service.

FIG. 5 is a diagram illustrating an example 500 of network entity energy usage reporting, in accordance with the present disclosure. Example 500 involves communications between an SMF, a network node (e.g., network node 110) and a network entity (e.g., a core network entity, such as a UPF).

As shown by reference number 510, the SMF may transmit, and the network node may receive, a request associated with a PDU session. For example, the request may be a request to establish or modify the PDU session. The network node may receive the request to establish the PDU session via an AMF. For example, the request to establish the PDU session may be an N2 PDU session request received from the AMF.

As shown by reference number 520, the SMF may transmit, and the network entity may receive, another request associated with the PDU session. For example, the request may be a request to establish or modify the PDU session. For example, the other request associated with the PDU session may be an N4 session establishment request.

As shown by reference number 530, the RAN and the network entity may establish a tunnel associated with the PDU session based at least in part on the requests associated with the PDU session. For example, the RAN and the network entity may exchange one or more PDUs (e.g., data traffic) of the PDU session over the tunnel. In some examples, the tunnel may be an N3 tunnel.

As shown by reference number 540, the network node may transmit, and the network entity may receive, energy usage information via the tunnel. The network node may report the energy usage information to the network entity in the user plane (e.g., energy reporting may be user-plane-based). For example, the network entity may forward the energy usage information in the upstream to the network entity.

The energy usage information may indicate the amount of energy consumed to deliver one or more PDUs to or from the UE. For example, the network node may convey energy usage for a specific packet or energy usage as an average over a previous time window. Additionally, or alternatively, the energy usage information may indicate activation or deactivation of an energy mode of operation in the downlink and/or the uplink. The network node may transmit the energy usage information to the network entity periodically or triggered by a triggering event. The periodicity and/or triggering event may be configured by an energy usage monitoring configuration, as described below. In some examples, the energy usage information may carry timestamp information (e.g., the energy usage information may carry a timestamp indicating a time at which the network node generated or transmitted the energy usage information).

In some aspects, the energy usage information may be specific to a PDU associated with the PDU session. For example, the network node may convey, and the network entity may receive, energy usage information associated with the PDU (e.g., the energy usage information for the PDU). For example, the energy usage information reported by the network node may be for energy consumption of a PDU received from the UE, and/or the energy usage information may indicate energy usage associated with previously delivering a PDU to the UE.

In some aspects, the energy usage information is specific to a QoS flow associated with the PDU session. For example, the network node may convey, and the network entity may receive, energy usage information associated with the QoS flow (e.g., the energy usage information for the QoS flow). For example, the energy usage information may indicate the energy usage associated with previously delivering multiple PDUs of a QoS flow and/or data radio bearer (DRB) to the UE.

In some aspects, the network node may transmit, and the network entity may receive, one or more PDUs containing header markings that indicate the energy usage information. For example, the network node may insert header markings in upstream traffic transmitted from the network node to the network entity. For example, the network node may convey the energy usage information (e.g., an energy usage report) via header information (e.g., in header information of a PDU). The network entity may receive the energy usage information via (e.g., in) the header markings carried in the upstream traffic. For example, the header markings may be included in a header (e.g., a general packet radio service (GPRS) tunneling protocol user plane (GTP-U) header) that is added to network traffic carried over the N3 interface by the network node. Information in the header may indicate the relevant QoS flow, PDU session, UE, or the like. In some examples, the network node may add energy usage information to the header.

In some examples, the header marking may be specific to the PDU (e.g., packet) that is carrying the header. In some examples, the marking may be for any packet carried on the QoS flow on which the PDU (e.g., packet) is conveyed, which may reduce bandwidth by adding the header marking for only one packet in the QoS flow (e.g., instead of for each packet in the QoS flow). The network node may transmit the header markings based at least in part on an energy usage monitoring configuration, as described below. In some examples, header information (e.g., the header markings) may carry the timestamp.

In some aspects, the network node may transmit, and the network entity may receive, one or more user plane protocol control PDUs containing the energy usage information. The user plane protocol control PDUs may include any suitable control plane packet exchanged via the tunnel. For example, the network node may transmit (e.g., send) user plane protocol control PDUs to convey the energy usage information. For example, the network node may convey the energy usage information (e.g., an energy usage report) via (e.g., in) a user plane protocol control PDU. In some examples, the network node may transmit the user plane protocol control PDUs based at least in part on an energy usage monitoring configuration, as described below.

As shown by reference number 550, the network entity may transmit, based at least in part on the energy usage information, an energy usage report. For example, the network entity may report, via the energy usage report, the energy usage information (e.g., energy usage reports received by the network entity from the network node) to the SMF. In some examples, the network entity may transmit an energy usage report that contains consolidated energy usage information (which the network entity received from the network node) and data usage information (which may be collected by the network entity). For example, the network entity may transmit consolidated energy and data usage reports to the SMF (e.g., based on an SMF configuration). Additionally, or alternatively, the network entity may regulate forwarding of downlink traffic toward the network node based on the energy usage reports received from the network node.

The network entity may transmit the energy usage report periodically or triggered by a triggering event. The periodicity and/or triggering event may be configured by an energy usage monitoring configuration, as described below. In some examples, the energy usage report may carry timestamp information (e.g., the energy usage report may carry a timestamp indicating a time at which the network node generated or transmitted the energy usage information, and/or a time at which the network generated or transmitted the energy usage report).

In some aspects, the energy usage report may be specific to a QoS flow associated with the PDU session. For example, the granularity of the energy usage report may be on the QoS-flow-level. For example, the network entity may report energy usage in term of QoS flows (e.g., the energy usage report may contain energy usage information for the QoS flow).

In some aspects, the energy usage report may be specific to an SDF associated with the PDU session. For example, the granularity of the energy usage report may be on the SDF-level. For example, the network entity may report energy usage in term of SDFs (e.g., the energy usage report may contain energy usage information for the SDF).

In some aspects, the energy usage report may be specific to the PDU session. For example, the granularity of the energy usage report may be on the PDU-session-level. For example, the network entity may report energy usage in term of PDU sessions (e.g., the energy usage report may contain energy usage information for the PDU session).

In some aspects, the network node may receive an energy usage monitoring configuration (e.g., an energy usage monitoring request) from the SMF (e.g., any suitable time before the network node transmits energy usage information). The energy usage monitoring configuration may include a request to evaluate energy consumption for delivering a PDU to the UE, a request for activation or deactivation of energy usage monitoring on a QoS flow or DRB that transports the PDU, a request to deliver a PDU using an energy mode of operation, a request to activate or deactivate an energy mode of operation in the downlink and/or the uplink, or the like. The network node may receive a configuration associated with energy usage monitoring from the SMF for a given PDU session. For example, the network node may receive the configuration from the SMF over the control plane (e.g., via the AMF over an N2 interface).

The energy usage monitoring configuration may include one or more of an indication of an allowed or maximum energy usage (e.g., an energy usage threshold), an indication of how to evaluate (e.g., calculate) energy consumed to deliver a PDU of the PDU session to the UE, an indication to activate or deactivate energy usage monitoring on a QoS flow or DRB that transports the PDU, a request to deliver the PDU using an energy mode of operation or to activate or deactivate an energy mode of operation, or the like.

Additionally, or alternatively, the network entity may receive an energy usage monitoring configuration from the SMF. For example, the SMF may configure, on the network entity, energy usage reporting from the network entity to the SMF and/or energy usage monitoring. For example, the SMF may activate or deactivate, on the RAN (e.g., the network node) and/or the network entity, energy usage reporting between the RAN and the network entity. The network node and/or the network entity may accept or reject the configuration.

In some aspects, the energy usage monitoring configuration (e.g., the energy usage threshold) may be specific to one or more QoS flows. For example, the energy usage monitoring configuration may specify a granularity of one QoS flow or a bundle of QoS flows. For example, the energy usage monitoring configuration may configure energy usage monitoring for the single QoS flows or the bundle of QoS flows. In other examples, the granularity specified by the energy usage monitoring configuration may be one or more PDU sessions, one or more service data flows (SDFs), a bundle of one or more QoS flow(s) and one or more SDFs, or the like.

In some aspects, the network entity may transmit, and the network node may receive, the energy usage monitoring configuration via the tunnel. For example, the network node may receive a request for energy monitoring for a downstream PDU or a QoS flow associated with multiple PDUs. In some examples, the network entity may transmit the energy usage configuration via the tunnel based on an SMF configuration and/or to support reporting to SMF. Thus, the network entity may request energy usage monitoring via the user plane to the network node. The granularity specified by the energy usage monitoring configuration may be one or more PDU sessions, one or more SDFs, a bundle of one or more QoS flow(s) and one or more SDFs, or the like.

In some aspects, the energy usage monitoring configuration may be specific to a PDU associated with the PDU session. For example, the energy usage monitoring configuration may apply to a PDU of the PDU session. For example, the network node may receive the energy usage monitoring configuration (e.g., a request for energy monitoring) for a downstream PDU.

In some aspects, the energy usage monitoring configuration (e.g., the energy usage threshold) may be specific to a QoS flow associated with the PDU session. For example, the energy usage monitoring configuration may apply to a QoS flow of the PDU session. For example, the network node may receive the energy usage monitoring configuration (e.g., a request for energy monitoring) for a QoS flow associated with multiple PDUs.

In some aspects, the network entity may transmit, and the network node may receive, one or more PDUs containing header markings that indicate the energy usage monitoring configuration. For example, the energy usage monitoring configuration may be included in header information of the PDU. For example, the network node may receive, via the header marking(s) of one or more PDUs, a request for energy monitoring for a downstream PDU or a QoS flow associated with the PDUs. For example, the header markings may be included in a header (e.g., a GTP-U header) that is added to network traffic carried over the N3 interface by the network entity. Information in the header may indicate the relevant QoS flow, PDU session, UE, or the like. In some examples, the network entity may add energy usage information to the header. In some examples, the header marking may be specific to the PDU (e.g., packet) that is carrying the header. In some examples, the marking may be for any packet carried on the QoS flow on which the PDU (e.g., packet) is conveyed, which may reduce bandwidth by adding the header marking for only one packet in the QoS flow (e.g., instead of for each packet in the QoS flow).

In some aspects, the network entity may transmit, and the network node may receive, one or more user plane protocol control PDUs that indicate the energy usage monitoring configuration. For example, the energy usage monitoring configuration may be included in the user plane protocol control PDU(s). For example, the network node may receive, through one or more user plane control PDUs, a request for energy monitoring for a downstream PDU or a QoS flow associated with multiple PDUs. For example, the network node may receive the energy usage monitoring configuration from the network entity over the N3 interface (e.g., and the network entity may receive the configuration from the SMF).

The network node transmitting the energy usage information via the tunnel, the network entity receiving the energy usage information via the tunnel, and/or the network entity transmitting the energy usage report may provide a user-plane-based solution for energy usage (e.g., efficiency) reporting, thereby enabling robust energy usage reporting and, ultimately, conserving energy consumed by a UE. For example, the network entity (e.g., the UPF) may obtain a significant portion of (e.g., all) user plane network traffic data flowing to or from the UE. As a result, the network entity may report energy usage based on energy usage information obtained, via the user plane, from the RAN (e.g., one or more network nodes).

Additionally, or alternatively, the network node transmitting the energy usage information via the tunnel, the network entity receiving the energy usage information via the tunnel, and/or the network entity transmitting the energy usage report may enable an energy consumption information exchange framework. The framework may enable 5G core (5GC) network functions and/or the RAN to provide energy consumption reports on a per-slice basis, per-PDU-session basis, per-QoS-flow basis, or the like. Additionally, or alternatively, the framework may introduce a maximum energy credit limit as a policy per service, energy consumption information in CDRs (e.g., for charging purposes), and/or energy efficiency modes in policy information; offer energy efficiency as a service to application functions and subscribers; cap energy consumed for specific services at a given energy consumption rate in the network; charge based on energy consumption (e.g., increased pricing above a given energy consumption rate); define different energy efficiency modes; and/or compute energy consumption on a per-network-slice basis, a per-PDU-session basis, a per-QoS-flow basis, or the like.

The network node receiving the energy usage monitoring configuration from the SMF may enable the network node to receive the energy usage monitoring configuration via the control plane, which may reduce impact on user plane traffic. The control plane may also carry detailed energy usage monitoring configuration information and/or piggyback the energy usage monitoring configuration on other configurations that are carried in the control plane. The network entity transmitting, and the network node receiving, the energy usage monitoring configuration via the tunnel may enable the energy usage monitoring configuration to be transmitted via a similar mechanism as the energy usage information (e.g., via the user plane). The user plane may enable dynamic monitoring activation or deactivation and/or fine-granularity reporting (e.g., per-PDU reporting).

As indicated above, FIG. 5 is provided as an example. Other examples may differ from what is described with respect to FIG. 5.

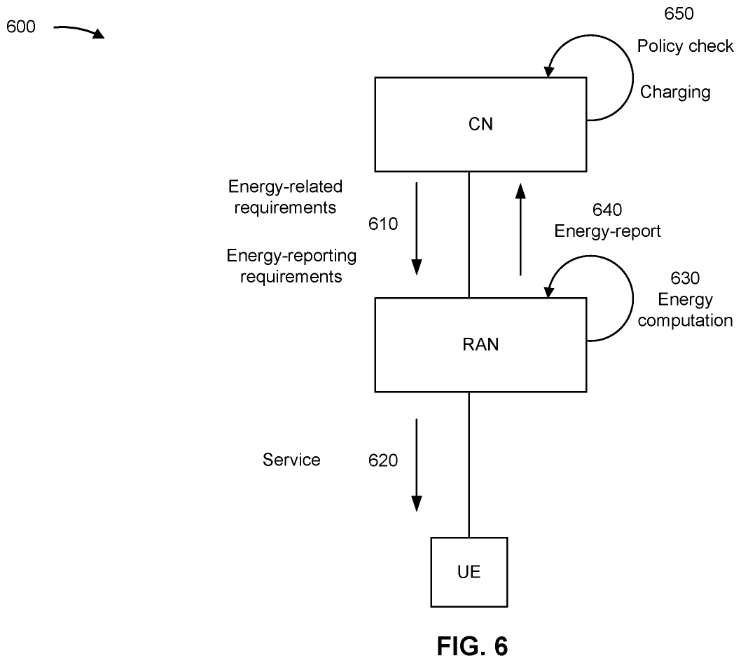

FIG. 6 is a diagram illustrating an example 600 of an energy usage reporting process, in accordance with the present disclosure. Example 600 involves communications between a core network (“CN”), a RAN, and a UE. The core network may include various network entities, such as an AMF, an SMF, a PCF, a CHF, and/or the like. The RAN may include one or more network nodes (e.g., network node 110). The UE may be connected to, and accessing services via, the RAN.

As shown by reference number 610, the core network may transmit, and the RAN may receive, an energy usage policy (e.g., requirements relating to energy usage or energy usage reporting). As shown by reference number 620, the RAN may provide a service to the UE. As shown by reference number 630, the RAN may perform an energy computation based on the energy usage policy. As shown by reference number 640, the RAN may transmit, and the core network may receive, an energy report in the user plane, which may impact the RAN and/or the core network. As shown by reference number 650, the core network may perform a check on an energy usage policy and/or implement charging based on the energy report received from the RAN.

As indicated above, FIG. 6 is provided as an example. Other examples may differ from what is described with respect to FIG. 6.

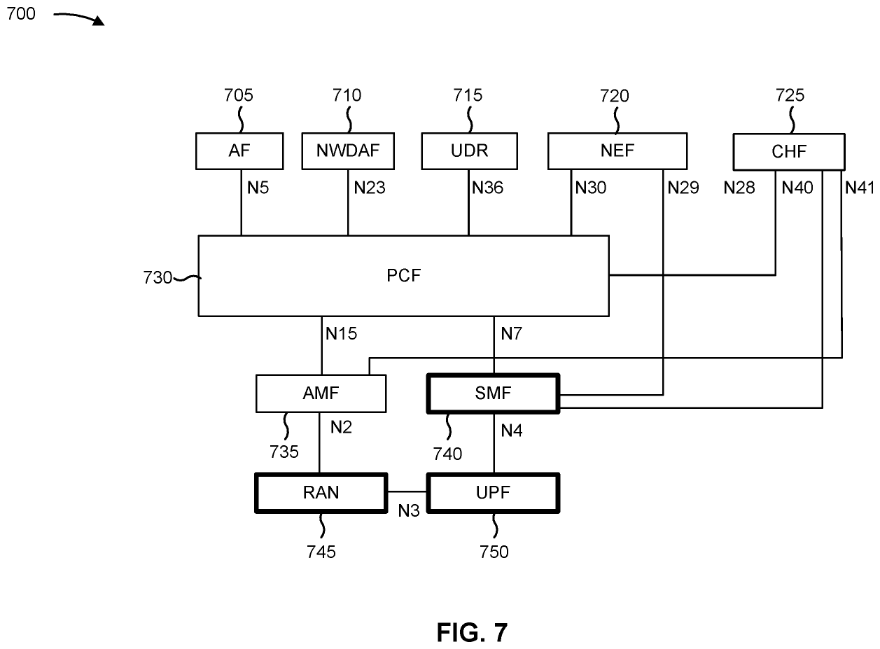

FIG. 7 is a diagram illustrating an example 700 of a 5G network architecture that supports network entity energy usage reporting, in accordance with the present disclosure. The 5G network architecture includes various network entities, including an AF 705, an NWDAF 710, a UDR 715, an NEF 720, a CHF 725, a PCF 730, an AMF 735, an SMF 740, a RAN 745, and a UPF 750. The 5G network architecture further includes interfaces (e.g., N5, N23, N36, and so forth) that enable communications between the network entities.

Example 700 may generally involve communications between the SMF 740, the RAN 745, and/or the UPF 750. For example, communications may occur between the SMF 740 and the UPF 750, communications may occur between the RAN 745 and the UPF 750 (e.g., via the N3 interface), and/or communications may occur between the RAN 745 and the SMF 740 via the AMF 735.

The SMF 740 may transmit, and the RAN 745 and the UPF 750 may receive, respective requests associated with a PDU session. The RAN 745 and the UPF 750 may establish, based at least in part on the requests, an N3 tunnel associated with the PDU session. The RAN 745 may transmit, and the UPF 750 may receive, energy usage information via the tunnel. The UPF 750 may transmit, to the SMF 740, based at least in part on the energy usage information, an energy usage report.

As indicated above, FIG. 7 is provided as an example. Other examples may differ from what is described with respect to FIG. 7.

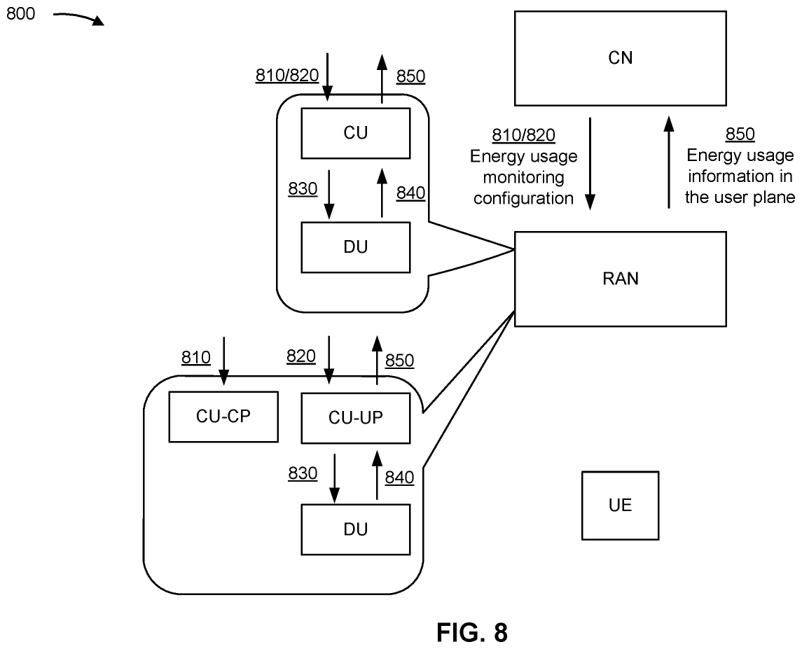

FIG. 8 is a diagram illustrating an example 800 of an energy usage reporting process involving a decomposed RAN, in accordance with the present disclosure. The decomposed RAN is configured to provide a network connectivity to a UE and communicate with a core network (“CN”). The decomposed RAN may be decomposed into a CU and a DU, and/or the CU may be decomposed into a CU-CP and a CU-UP. The CU-CP and the CU-UP may communicate over an E1 interface. In some examples, the decomposed RAN may include a network node (e.g., network node 110) that contains at least one CU (e.g., at least one CU-CP and at least one CU-UP) and at least one DU. The decomposed RAN may include multiple CU-UPs to allow for load balancing.

As shown by reference number 810, the core network may transmit, and the decomposed RAN may receive, an energy usage monitoring configuration by a CU-CP (and/or a CU) of the network node. For example, the CU-CP may receive the energy usage monitoring configuration from an SMF of the core network via an AMF of the core network.

As shown by reference number 820, the core network may transmit, and the decomposed RAN may receive, an energy usage monitoring configuration by a CU-UP (and/or a CU) of the network node. For example, the CU-UP may receive the energy usage monitoring configuration via the tunnel (e.g., from a UPF of the core network). Thus, the decomposed RAN may receive the energy usage monitoring configuration by the CU-CP (reference number 810) or by the CU-UP (reference number 820).

As shown by reference number 830, the CU-CP, CU-UP, and/or CU may transmit, to the DU, based at least in part on the energy usage monitoring configuration, a request to perform energy usage monitoring. In some examples, the CU-CP may configure energy usage reporting from the CU-UP to the core network (e.g., the UPF). In some examples, the CU-CP may configure energy usage reporting from the CU-UP to the CU-CP.

In some examples, the CU-CP (and/or the CU) may activate or deactivate, on the DU and/or the CU (and/or the CU-UP), user-plane-based reporting between the DU and the CU-CP (and/or the CU). In some examples, the CU-CP (and/or the CU) may specify a granularity for the energy usage reporting (e.g., DRB or bundle). In some examples, the CU-CP may configure the reporting on the DU and/or the CU-UP upon receiving the energy usage monitoring configuration from the SMF. In some examples, the CU-UP may configure or request reporting on the DU via the user plane (e.g., using header markings and/or user plane protocol control PDUs) on a per-PDU or per-DRB basis. In some examples, the CU-CP may provide, to the CU-UP, information regarding an allowed or maximum energy usage and granularity (e.g., UE, PDU session, QoS flow, DRB, bundle, or the like). The CU (e.g., the CU-CP and/or the CU-UP) and/or the DU may accept or reject the energy usage monitoring configuration.

As shown by reference number 840, the CU-CP (and/or the CU) receives energy usage information from the DU. For example, the CU-CP may receive the energy usage information via the CU-UP. The DU may report the energy usage information to the CU-CP and/or the CU in the user plane. For example, the DU may send, to the CU-CP and/or the CU, the energy usage report via header markings or user plane protocol control PDUs. In some examples, the energy usage report may have a per-PDU or per-DRB granularity. In some examples, the CU-UP may regulate forwarding of downlink traffic toward the DU based on energy usage reports received from the DU. Energy usage reports from the CU-UP to the CU-CP may be based on energy usage reports from the DU.

As shown by reference number 850, the CU-UP (and/or the CU) transmits the energy usage information via the tunnel to the core network (e.g., to the UPF). The CU-UP and/or the CU may report the energy usage information in the user plane. For example, the CU-UP (and/or the CU) may send, to the core network, the energy usage report via header markings or user plane protocol control PDUs. In some examples, the energy usage report may have a per-PDU or per-DRB granularity. Energy usage reports from the CU (and/or from the CU-UP) to the UPF may be based on energy usage reports from the DU.

Receiving the energy usage monitoring configuration by a CU-CP may enable a decomposed RAN to receive the energy usage monitoring configuration from an SMF. Receiving the energy usage monitoring configuration by a CU-UP may enable a decomposed RAN to receive the energy usage monitoring configuration from a UPF. Transmitting the energy usage information by a CU-UP may enable a decomposed RAN to transmit the energy usage information to the UPF.

As indicated above, FIG. 8 is provided as an example. Other examples may differ from what is described with respect to FIG. 8.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with energy usage reporting by a network entity.

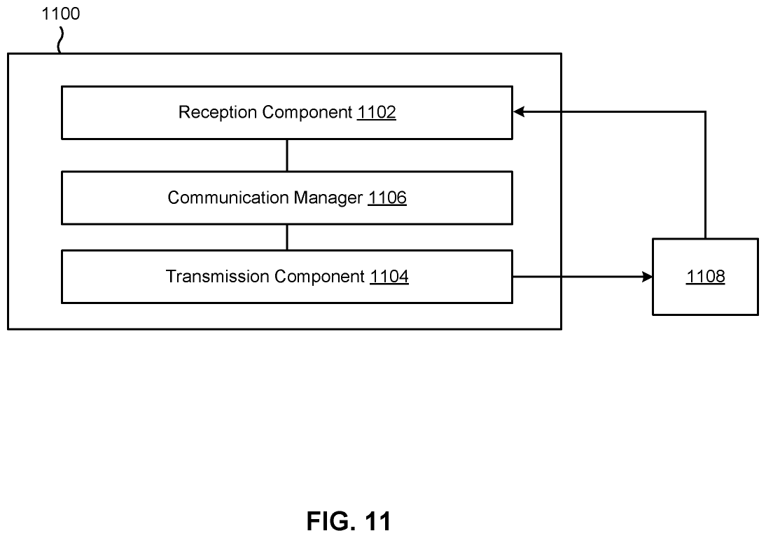

As shown in FIG. 9, in some aspects, process 900 may include receiving a request associated with a PDU session (block 910). For example, the network node (e.g., using reception component 1102 and/or communication manager 1106, depicted in FIG. 11) may receive a request associated with a PDU session, as described above.

As further shown in FIG. 9, in some aspects, process 900 may include establishing, based at least in part on the request, a tunnel associated with the PDU session (block 920). For example, the network node (e.g., using communication manager 1106, depicted in FIG. 11) may establish, based at least in part on the request, a tunnel associated with the PDU session, as described above.

As further shown in FIG. 9, in some aspects, process 900 may include transmitting, via the tunnel, energy usage information (block 930). For example, the network node (e.g., using transmission component 1104 and/or communication manager 1106, depicted in FIG. 11) may transmit, via the tunnel, energy usage information, as described above.

Process 900 may include additional aspects, such as any single aspect or any combination of aspects described below and/or in connection with one or more other processes described elsewhere herein.

In a first aspect, process 900 includes receiving an energy usage monitoring configuration from an SMF.

In a second aspect, the energy usage monitoring configuration is specific to one or more QoS flows.

In a third aspect, receiving the energy usage monitoring configuration includes receiving the energy usage monitoring configuration by a CU-CP of the network node, and process 900 includes transmitting, by the CU-CP to a DU of the network node, based at least in part on the energy usage monitoring configuration, a request to perform energy usage reporting.

In a fourth aspect, process 900 includes receiving an energy usage monitoring configuration via the tunnel.

In a fifth aspect, receiving the energy usage monitoring configuration includes receiving one or more PDUs containing header markings that indicate the energy usage monitoring configuration.

In a sixth aspect, receiving the energy usage monitoring configuration includes receiving one or more user plane protocol control PDUs that indicate the energy usage monitoring configuration.

In a seventh aspect, the energy usage monitoring configuration is specific to a PDU associated with the PDU session.

In an eighth aspect, the energy usage monitoring configuration is specific to a QoS flow associated with the PDU session.

In a ninth aspect, receiving the energy usage monitoring configuration includes receiving the energy usage monitoring configuration by a CU-UP of the network node, and process 900 includes transmitting, by the CU-UP to a DU of the network node, based at least in part on the energy usage monitoring configuration, a request to perform energy usage reporting.

In a tenth aspect, transmitting the energy usage information includes transmitting one or more PDUs containing header markings that indicate the energy usage information.

In an eleventh aspect, transmitting the energy usage information includes transmitting one or more user plane protocol control PDUs containing the energy usage information.

In a twelfth aspect, the energy usage information is specific to a PDU associated with the PDU session.

In a thirteenth aspect, the energy usage information is specific to a QoS flow associated with the PDU session.

In a fourteenth aspect, process 900 includes receiving, by a CU-UP of the network node, the energy usage information from a DU of the network node, and transmitting the energy usage information includes transmitting the energy usage information by the CU-UP of the network node.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network entity or an apparatus of a network entity, in accordance with the present disclosure. Example process 1000 is an example where the apparatus or the network entity (e.g., the network entity of FIG. 5) performs operations associated with energy usage reporting by the network entity.

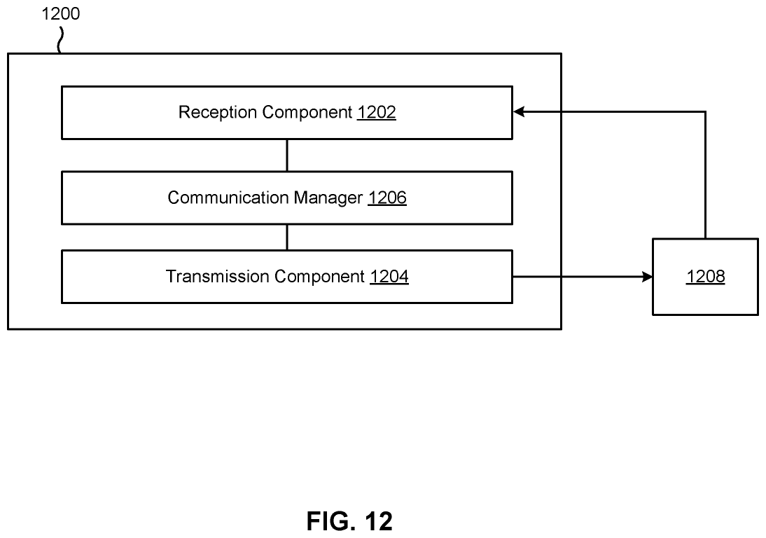

As shown in FIG. 10, in some aspects, process 1000 may include receiving a request associated with a PDU session (block 1010). For example, the network entity (e.g., using reception component 1202 and/or communication manager 1206, depicted in FIG. 12) may receive a request associated with a PDU session, as described above.

As further shown in FIG. 10, in some aspects, process 1000 may include establishing, based at least in part on the request, a tunnel associated with the PDU session (block 1020). For example, the network entity (e.g., using communication manager 1206, depicted in FIG. 12) may establish, based at least in part on the request, a tunnel associated with the PDU session, as described above.

As further shown in FIG. 10, in some aspects, process 1000 may include receiving, via the tunnel, energy usage information (block 1030). For example, the network entity (e.g., using reception component 1202 and/or communication manager 1206, depicted in FIG. 12) may receive, via the tunnel, energy usage information, as described above.

As further shown in FIG. 10, in some aspects, process 1000 may include transmitting, based at least in part on the energy usage information, an energy usage report (block 1040). For example, the network entity (e.g., using transmission component 1204 and/or communication manager 1206, depicted in FIG. 12) may transmit, based at least in part on the energy usage information, an energy usage report, as described above.

Process 1000 may include additional aspects, such as any single aspect or any combination of aspects described below and/or in connection with one or more other processes described elsewhere herein.

In a first aspect, process 1000 includes transmitting an energy usage monitoring configuration via the tunnel.

In a second aspect, receiving the energy usage information includes receiving one or more PDUs containing header markings that indicate the energy usage information.

In a third aspect, receiving the energy usage information includes receiving one or more user plane protocol control PDUs containing the energy usage information.

In a fourth aspect, the energy usage information is specific to a PDU associated with the PDU session.

In a fifth aspect, the energy usage information is specific to a QoS flow associated with the PDU session.

In a sixth aspect, the energy usage report is specific to a QoS flow associated with the PDU session.

In a seventh aspect, the energy usage report is specific to an SDF associated with the PDU session.

In an eighth aspect, the energy usage report is specific to the PDU session.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 5-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a request associated with a PDU session. The communication manager 1106 may establish, based at least in part on the request, a tunnel associated with the PDU session. The transmission component 1104 may transmit, via the tunnel, energy usage information. The reception component 1102 may receive an energy usage monitoring configuration from an SMF. The reception component 1102 may receive an energy usage monitoring configuration via the tunnel.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network entity, or a network entity may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 160 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 5-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network entity described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network entity described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network entity described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive a request associated with a PDU session. The communication manager 1206 may establish, based at least in part on the request, a tunnel associated with the PDU session. The reception component 1202 may receive, via the tunnel, energy usage information. The transmission component 1204 may transmit, based at least in part on the energy usage information, an energy usage report. The transmission component 1204 may transmit an energy usage monitoring configuration via the tunnel.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a network node, comprising: receiving a request associated with a PDU session; establishing, based at least in part on the request, a tunnel associated with the PDU session; and transmitting, via the tunnel, energy usage information.

Aspect 2: The method of Aspect 1, further comprising: receiving an energy usage monitoring configuration from an SMF.

Aspect 3: The method of Aspect 2, wherein the energy usage monitoring configuration is specific to one or more QoS flows.

Aspect 4: The method of Aspect 2, wherein receiving the energy usage monitoring configuration includes receiving the energy usage monitoring configuration by a CU-CP of the network node.

Aspect 5: The method of any of Aspects 1-4, further comprising: receiving an energy usage monitoring configuration via the tunnel.

Aspect 6: The method of Aspect 5, wherein receiving the energy usage monitoring configuration includes receiving one or more PDUs containing header markings that indicate the energy usage monitoring configuration.

Aspect 7: The method of Aspect 5, wherein receiving the energy usage monitoring configuration includes receiving one or more user plane protocol control PDUs that indicate the energy usage monitoring configuration.

Aspect 8: The method of Aspect 5, wherein the energy usage monitoring configuration is specific to a PDU associated with the PDU session.

Aspect 9: The method of Aspect 5, wherein the energy usage monitoring configuration is specific to a QoS flow associated with the PDU session.

Aspect 10: The method of Aspect 5, wherein receiving the energy usage monitoring configuration includes receiving the energy usage monitoring configuration by a CU-UP of the network node.

Aspect 11: The method of any of Aspects 1-10, wherein transmitting the energy usage information includes transmitting one or more PDUs containing header markings that indicate the energy usage information.

Aspect 12: The method of any of Aspects 1-11, wherein transmitting the energy usage information includes transmitting one or more user plane protocol control PDUs containing the energy usage information.

Aspect 13: The method of any of Aspects 1-12, wherein the energy usage information is specific to a PDU associated with the PDU session.

Aspect 14: The method of any of Aspects 1-13, wherein the energy usage information is specific to a QoS flow associated with the PDU session.

Aspect 15: The method of any of Aspects 1-14, wherein transmitting the energy usage information includes transmitting the energy usage information by a CU-UP of the network node.

Aspect 16: A method of wireless communication performed by a network entity, comprising: receiving a request associated with a PDU session; establishing, based at least in part on the request, a tunnel associated with the PDU session; receiving, via the tunnel, energy usage information; and transmitting, based at least in part on the energy usage information, an energy usage report.

Aspect 17: The method of Aspect 16, further comprising: transmitting an energy usage monitoring configuration via the tunnel.

Aspect 18: The method of any of Aspects 16-17, wherein receiving the energy usage information includes receiving one or more PDUs containing header markings that indicate the energy usage information.

Aspect 19: The method of any of Aspects 16-18, wherein receiving the energy usage information includes receiving one or more user plane protocol control PDUs containing the energy usage information.

Aspect 20: The method of any of Aspects 16-19, wherein the energy usage information is specific to a PDU associated with the PDU session.

Aspect 21: The method of any of Aspects 16-20, wherein the energy usage information is specific to a QoS flow associated with the PDU session.

Aspect 22: The method of any of Aspects 16-21, wherein the energy usage report is specific to a QoS flow associated with the PDU session.

Aspect 23: The method of any of Aspects 16-22, wherein the energy usage report is specific to an SDF associated with the PDU session.

Aspect 24: The method of any of Aspects 16-23, wherein the energy usage report is specific to the PDU session.

Aspect 25: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-24.

Aspect 26: An apparatus for wireless communication at a device, the apparatus comprising one or more memories and one or more processors coupled to the one or more memories, the one or more processors configured to cause the device to perform the method of one or more of Aspects 1-24.

Aspect 27: An apparatus for wireless communication, the apparatus comprising at least one means for performing the method of one or more of Aspects 1-24.

Aspect 28: A non-transitory computer-readable medium storing code for wireless communication, the code comprising instructions executable by one or more processors to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

Aspect 30: A device for wireless communication, the device comprising a processing system that includes one or more processors and one or more memories coupled with the one or more processors, the processing system configured to cause the device to perform the method of one or more of Aspects 1-24.

Aspect 31: An apparatus for wireless communication at a device, the apparatus comprising one or more memories and one or more processors coupled to the one or more memories, the one or more processors individually or collectively configured to cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A network node for wireless communication, comprising:
one or more memories; and
one or more processors, coupled to the one or more memories, which are configured, individually or in any combination, to:
receive a request associated with a protocol data unit (PDU) session;
establish, based at least in part on the request, a tunnel associated with the PDU session; and
transmit, via the tunnel, energy usage information.

2. The network node of claim 1, wherein the one or more processors are further configured, individually or in any combination, to:
receive an energy usage monitoring configuration from a session management function (SMF).

3. The network node of claim 2, wherein the energy usage monitoring configuration is specific to one or more quality of service (QoS) flows.

4. The network node of claim 2, wherein the one or more processors, to receive the energy usage monitoring configuration, are configured to receive the energy usage monitoring configuration by a central unit control plane (CU-CP) of the network node, and wherein the one or more processors are further configured, individually or in any combination, to transmit, by the CU-CP to a distributed unit (DU) of the network node, based at least in part on the energy usage monitoring configuration, a request to perform energy usage reporting.

5. The network node of claim 1, wherein the one or more processors are further configured, individually or in any combination, to:
receive an energy usage monitoring configuration via the tunnel.

6. The network node of claim 5, wherein the one or more processors, to receive the energy usage monitoring configuration, are configured to receive one or more PDUs containing header markings that indicate the energy usage monitoring configuration.

7. The network node of claim 5, wherein the one or more processors, to receive the energy usage monitoring configuration, are configured to receive one or more user plane protocol control PDUs that indicate the energy usage monitoring configuration.

8. The network node of claim 5, wherein the energy usage monitoring configuration is specific to a PDU associated with the PDU session.

9. The network node of claim 5, wherein the energy usage monitoring configuration is specific to a quality of service (QoS) flow associated with the PDU session.

10. The network node of claim 5, wherein the one or more processors, to receive the energy usage monitoring configuration, are configured to receive the energy usage monitoring configuration by a central unit user plane (CU-UP) of the network node, and wherein the one or more processors are further configured, individually or in any combination, to transmit, by the CU-UP to a distributed unit (DU) of the network node, based at least in part on the energy usage monitoring configuration, a request to perform energy usage reporting.

11. The network node of claim 1, wherein the one or more processors, to transmit the energy usage information, are configured to transmit one or more PDUs containing header markings that indicate the energy usage information.

12. The network node of claim 1, wherein the one or more processors, to transmit the energy usage information, are configured to transmit one or more user plane protocol control PDUs containing the energy usage information.

13. The network node of claim 1, wherein the energy usage information is specific to a PDU associated with the PDU session.

14. The network node of claim 1, wherein the energy usage information is specific to a quality of service (QoS) flow associated with the PDU session.

15. The network node of claim 1, wherein the one or more processors are further configured, individually or in any combination, to receive, by a central unit user plane (CU-UP) of the network node, the energy usage information from a distributed unit (DU) of the network node, and wherein the one or more processors, to transmit the energy usage information, are configured to transmit the energy usage information by the CU-UP.

16. A network entity for wireless communication, comprising:
one or more memories; and
one or more processors, coupled to the one or more memories, which are configured, individually or in any combination, to:
receive a request associated with a protocol data unit (PDU) session;
establish, based at least in part on the request, a tunnel associated with the PDU session;
receive, via the tunnel, energy usage information; and
transmit, based at least in part on the energy usage information, an energy usage report.

17. The network entity of claim 16, wherein the one or more processors are further configured, individually or in any combination, to:
transmit an energy usage monitoring configuration via the tunnel.

18. The network entity of claim 16, wherein the one or more processors, to receive the energy usage information, are configured to receive one or more PDUs containing header markings that indicate the energy usage information.

19. The network entity of claim 16, wherein the one or more processors, to receive the energy usage information, are configured to receive one or more user plane protocol control PDUs containing the energy usage information.

20. The network entity of claim 16, wherein the energy usage information is specific to a PDU associated with the PDU session.

21. The network entity of claim 16, wherein the energy usage information is specific to a quality of service (QoS) flow associated with the PDU session.

22. The network entity of claim 16, wherein the energy usage report is specific to a quality of service (QoS) flow associated with the PDU session.

23. The network entity of claim 16, wherein the energy usage report is specific to a service data flow (SDF) associated with the PDU session.

24. The network entity of claim 16, wherein the energy usage report is specific to the PDU session.

25. A method of wireless communication performed by a network node, comprising:
receiving a request associated with a protocol data unit (PDU) session;
establishing, based at least in part on the request, a tunnel associated with the PDU session; and
transmitting, via the tunnel, energy usage information.

26. The method of claim 25, further comprising:
receiving an energy usage monitoring configuration from a session management function (SMF).

27. The method of claim 25, further comprising:
receiving an energy usage monitoring configuration via the tunnel.

28. A method of wireless communication performed by a network entity, comprising:
receiving a request associated with a protocol data unit (PDU) session;
establishing, based at least in part on the request, a tunnel associated with the PDU session;
receiving, via the tunnel, energy usage information; and
transmitting, based at least in part on the energy usage information, an energy usage report.

29. The method of claim 28, wherein receiving the energy usage information includes receiving one or more PDUs containing header markings that indicate the energy usage information.

30. The method of claim 28, wherein receiving the energy usage information includes receiving one or more user plane protocol control PDUs containing the energy usage information.
